(19) United States
(12) Patent Application Publication
(10) Pub. No.: US 2015/0375905 A1
(43) Pub. Date: Dec. 31, 2015

(54) SAUCE AND CONDIMENT DISPENSER

(71) Applicant: Nicolas Caunant, Cierrey (FR)

(72) Inventor: Nicolas Caunant, Cierrey (FR)

(21) Appl. No.: 14/769,075

(22) PCT Filed: Jan. 28, 2014
(86) PCT No.: PCT/EP2014/051583

§ 371 Date: Aug. 19, 2015

(30) Foreign Application Priority Data
Feb. 19, 2013 (FR) 1300360

(51) Int. Cl. B65D 35/30; B65B 43/08; B65B 7/02; A23L 1/22; B65B 3/04

(52) U.S. Cl. CPC B65D 35/30; A23L 1/22; B65B 3/045; B65B 7/02; B65B 43/08; A23V 2002/00

(57) ABSTRACT

A device for packaging and dispensing viscous and/or pasty products comprising a sachet (9) for protecting the product until it is in its final place of use, where it performs the function of a dispenser. The sachet exhibits the shape of a “W”, so as to obtain a flat bottom, which is provided with cuts (7) acting as a valve, thereby allowing the product to be dispensed. A removable protective seal (11) covers these valves (7). The device for packaging and dispensing comprises a reusable enclosure (5) of cylindrical form made from a plastics material comprising two ends, one receiving a piston (3) and the other the sachet. The sachet with a flat bottom closes off the end of the enclosure. The piston is inserted at the other end of the enclosure, so as to compress the sachet and expel the contents thereof through its valves (7) that are cut into the bottom of the sachet.

The present invention relates to a sauce and condiment dispenser and, in particular, to a packaging allowing viscous and/or pasty types of sauces and condiments to be protected, wrapped, stored, transported and dispensed by means of a dosing gun mechanism.

Packaging and wrapping of viscous and pasty products, such as mustard, ketchup, mayonnaise, spread and all similar products, are commonly used in fast-food restaurants. In order to deal with the high demand for sauce in the kitchens of fast-food restaurants, these products are commonly packaged and wrapped in cartridges and are dispensed by means of a mechanical system of the dosing gun type. These guns are based on the same principle as mastic guns. An example of this type of dosing gun may be found in U.S. Pat. No. 4,830,231. Although these packages and wrappings have been effective, they do have a number of disadvantages.

It is recommended to eliminate or to reduce the consumption of packages which do not provide added value for the product or for the user. Even a very small quantity of eliminated packaging may produce a not insignificant effect on the environment and a significant reduction in the packaging costs because of the very large quantities of product consumed and used by the agro-food industry and the fast-food restaurants sector. However, in order to eliminate these materials without any added value and to preserve the functionality of the unit, it is necessary to study and to understand the function of each element making up the sauce dispenser function so as to propose an alternative concept to the solutions that are currently available on the market. The cartridges of sauce that are currently available in the fast-food restaurants sector are of paper construction forming a tube, performing the function of an enclosure in which the product is packaged, wrapped, protected, transported and stored, and having two ends, one having the function of a piston and, as such, forcing the product through the second end provided with a valve system which performs the dispensing function. These sauce cartridges also involve numerous types of materials, paper, plastic and hot-melt adhesive, representing a very large number of packages for each cartridge, which, after having been consumed and used in the kitchen, must be disposed of, which, depending on these same quantities of products consumed and used in the agro-food sector and the fast-food restaurants sector, represents an astronomical number of packages to be disposed of in terms of both weight and volume. This type of cartridge may be found under the international publication number WO 2009/023375 (A2)—bibliographical data: EP 2185445 (A1). It is necessary to revise and rework these packages in order to propose a novel sauce dispenser, and in this way to rework these functions and to be able to reuse whatever may be reusable in each novel package, and to propose a novel concept for an improved and optimized sauce dispenser. It is also necessary to improve and to optimize the consumption of packaging materials, but also the means and the costs of production associated with these same packaging materials.

The invention has as its object a device for packaging and dispensing viscous and/or pasty sauce and condiments. The packaging and dispensing device consists of a sachet made from a flexible film of the plastic film type, containing the product to be dispensed and allowing the product to be protected, stored and transported until it is in its final place of use, where it allows the contents thereof to be dispensed. This sachet is of the type known in English as “Doypack”, that is to say having a so-called “W” shape, so as to obtain a flat bottom through which the product is dispensed. This flat bottom is provided with fine cuts in the material acting as a valve, thereby allowing the product to be dispensed. A removable seal may cover these valves, which protects them and will protect the product from the time of its manufacture until it is in its place of use. This seal also performs a function as a tamper-proof seal.

In order to allow dispensing, the packaging device requires an enclosure which is generally of cylindrical shape and which may be reused. This enclosure consists of two ends, one receiving a piston and the other the sachet with a flat bottom. The piston is used in order to apply a force to the sachet and to expel the product contained therein through valves on the flat bottom of the sachet. This piston may be reused, like the enclosure. The sachet with a flat bottom is inserted into this enclosure via the other end, having as its final position the flat bottom closing off the other end, with cuts in the bottom of the flat sachet for dispensing the product. In the case in which a reinforcement of the bottom of the flat sachet is necessary, for example in order to prevent the bottom of the flat sachet from deforming under the effect of the force exerted by the piston in the course of the dispensing operations, a reinforcement on this face may be provided by means of a disk, which may be made from a semi-rigid or rigid plastics material and which may be assembled on the dosing gun or welded directly on the bottom of the sachet. The seal may have a portion folded back on itself, permitting more simple and ergonomic peeling by the final user.

Other aims, characterizing features and advantages of the invention will be appreciated from a perusal of the following description, which is provided solely by way of non-restrictive example and is made with reference to the accompanying drawings, in which:

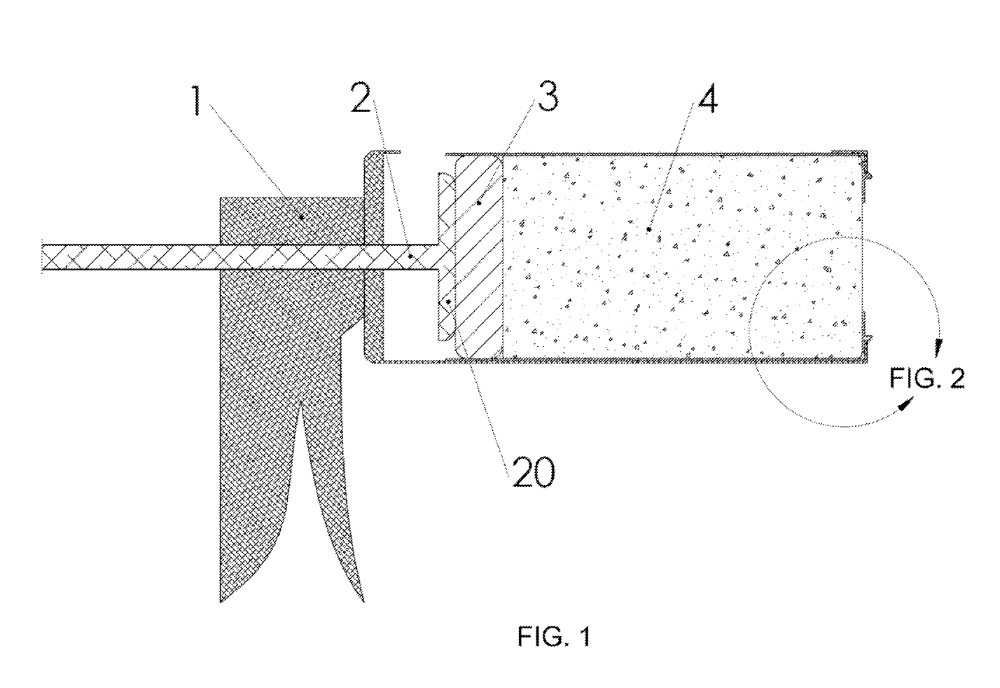

FIG. 1 illustrates a cross-sectional view of a device for packaging and dispensing sauce and condiment, mounted in a dosing gun, according to the present invention;

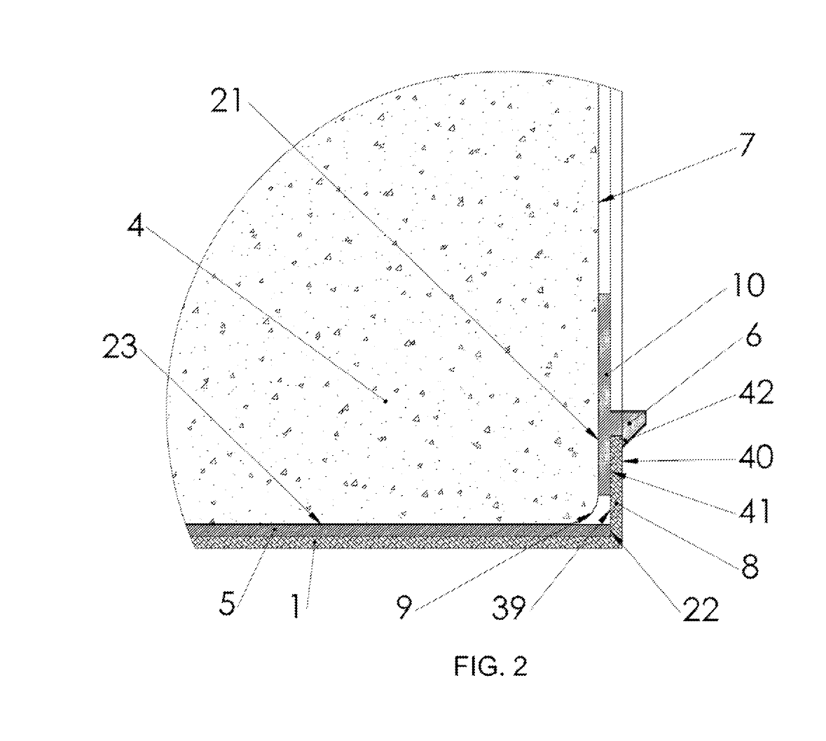

FIG. 2 is an enlargement of the dispensing zone, once the unit comprising the elements performing the dispensing function is mounted in the dosing gun;

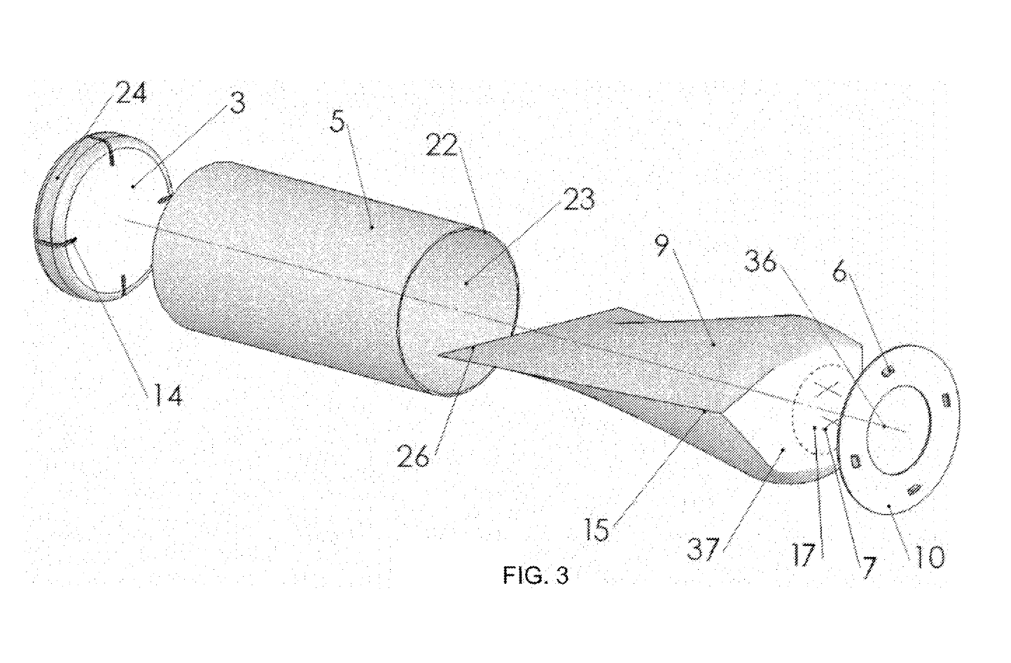

FIG. 3 is an exploded view of the piston, cylinder, sachet and reinforcement assembly;

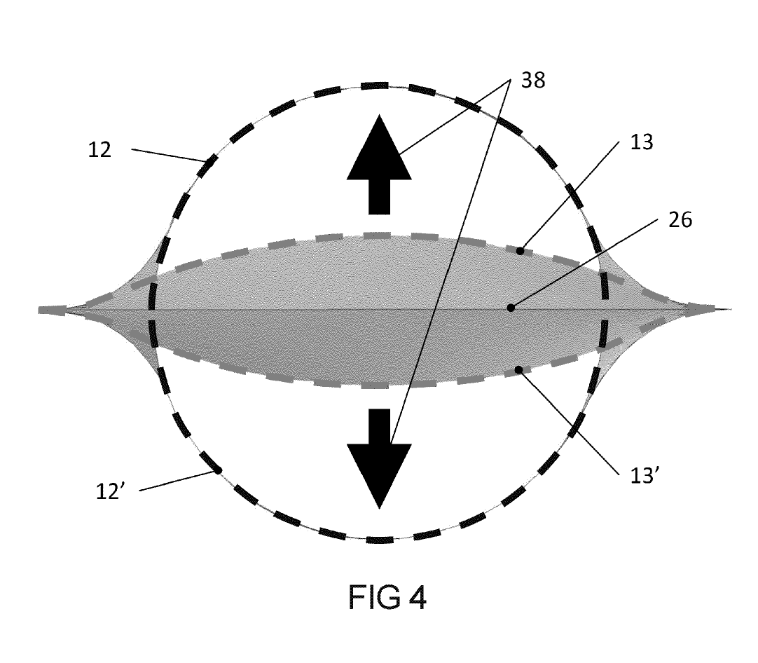

FIG. 4 shows the deformation of the lateral walls of the sachet with a flat bottom, once they have been subjected to pressure by the piston;

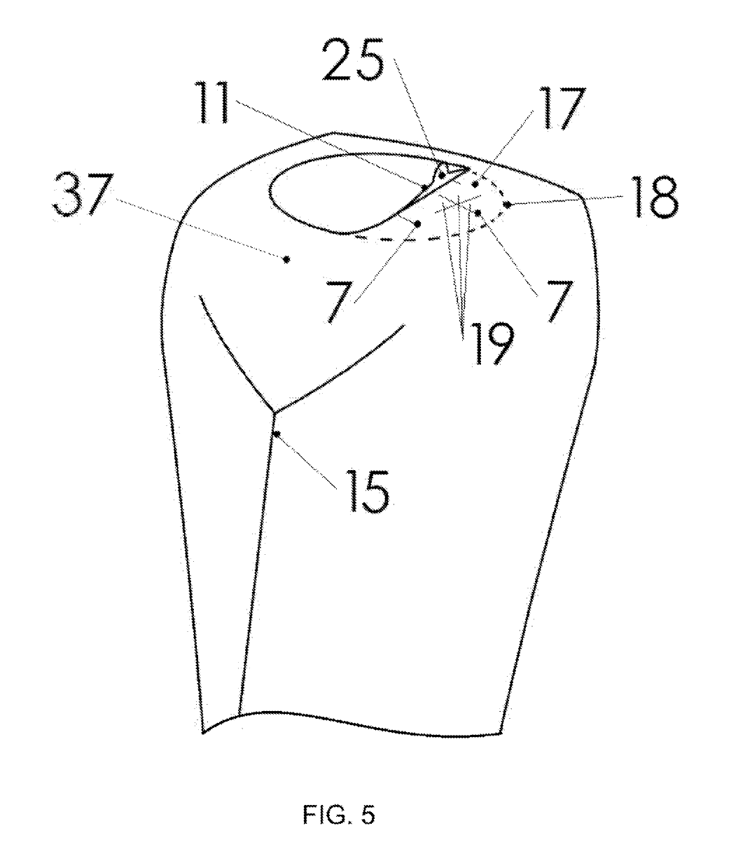

FIG. 5 depicts the sachet with a flat bottom and its dispensing zone containing valves and a seal, according to the present invention;

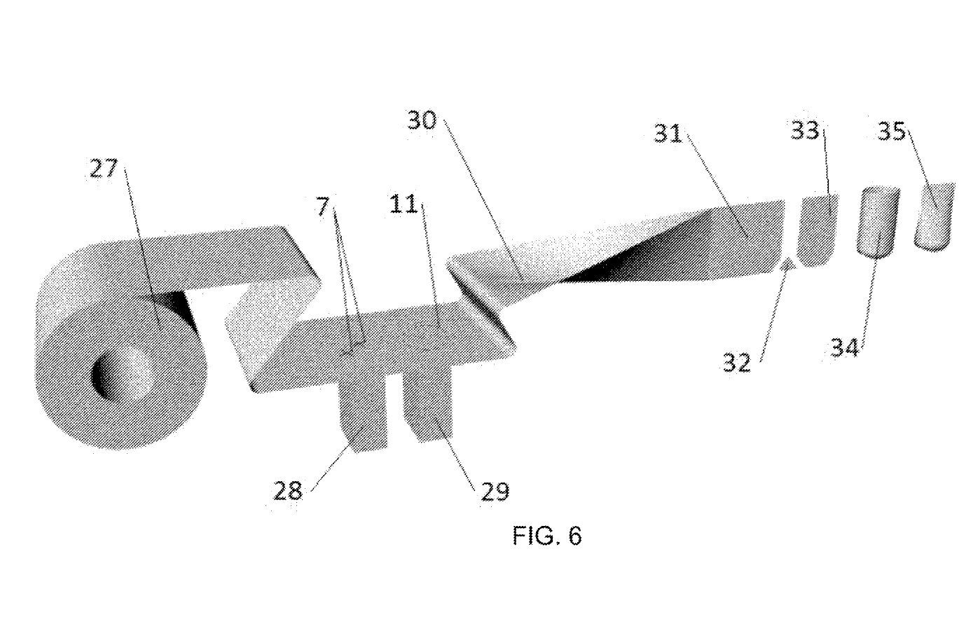

FIG. 6 depicts an example of a wrapping line starting from a reel of flexible film, according to the present invention; and

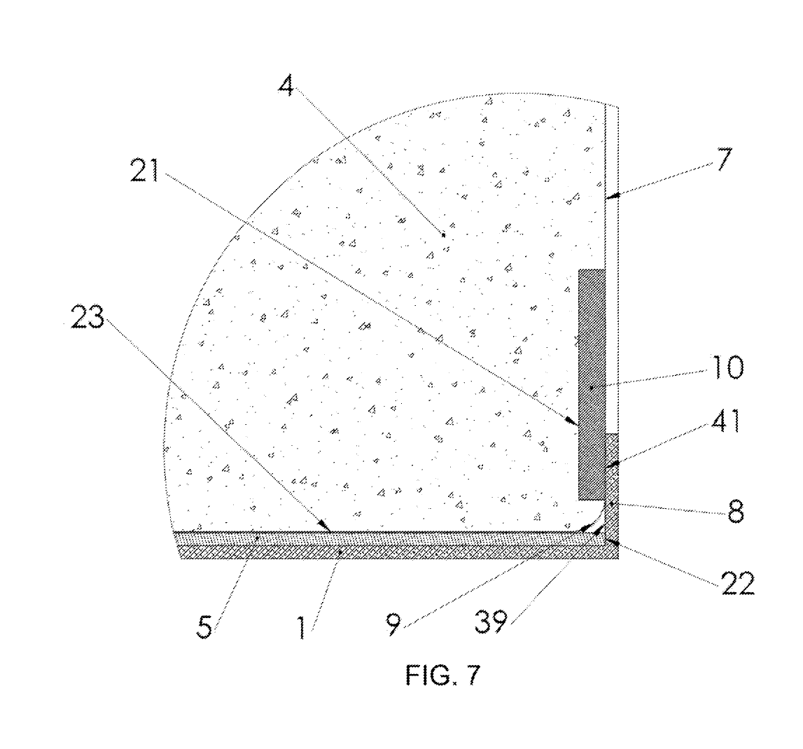

FIG. 7 depicts an enlargement of the dispensing zone, according to another embodiment of the invention.

The designation 1 generally refers to a dosing gun unit used for dispensing and dosing any type of pasty and/or viscous product 4 such as ketchup, mustard, mayonnaise, sandwich spread and/or all similar products. This type of pasty and/or viscous product 4 may be manufactured from water and/or oil. As illustrated, the dosing gun 1 is equipped with a trigger system enabling the actuation and the displacement of a shaft 2 which, at its end 20, possesses a sufficient surface area to exert a force on the piston 3, which subjects the sachet with a flat bottom 9 to pressure inside an enclosure 5 and expels its contents 4 through the exchange surface 17 containing one or a plurality of openings 7. During the dosage operation, the piston 3 is displaced in the direction of the exchange surface 17. This shaft 2 may be actuated manually with the help of a trigger system or may be semi-automatic and/or automatic by means of a motor powered by electrical energy or air.

The sachet with a flat bottom identified as 9 consists of three elements or surfaces, being the front face 13, the rear face 13′ as depicted in FIG. 4, and the bottom of the sachet with a flat bottom identified as 37 as depicted in FIG. 5 and FIG. 3. The base 37 of the sachet with a flat bottom 9 is obtained by folding in the shape of a W when the latter is being formed, according to the representation 30 in FIG. 6, which, once it has been formed and is standing upright, makes it possible to have a partial or total plane surface depending on the angles selected for the lateral welds 15. The lateral welds with the reference 15 in FIGS. 3 and 5 show the profile of this W-shaped fold. The base 37 of the sachet with a flat bottom contains the exchange surface 17, said surface being only a specific zone on the total surface of the bottom 37, having the function of dispensing the product 4 that the packaging contains.

The upper weld identified as 26 allows the sachet 9 to be sealed and closed once the latter has been filled with its contents 4. This weld may be of linear shape, as illustrated in FIG. 3, being a physical materialization of the present invention, although it may also be of circular shape. These three elements are also made from the same material, taken from the same sheet or from the same reel 27, as illustrated in FIG. 6. It generally consists of a soft, flexible material, of which the structure, which may be a simple PEBD, but which, depending on the needs in terms of protection and permeability, may require a multi-layered material, ensures the integrity of its contents.

The dimensions of the sachet with a flat bottom 9 are closely linked to the accessories serving the dispensing function, making reference at this point to the tube 5 and to piston 3. Depending on the interior diameter of the tube 5 and, by its nature, that of its piston 3, the width of the sachet with a flat bottom, in this particular case being the length of the weld 26 which is perfectly parallel to the base of the sachet with a flat bottom, should correspond to half of the value of the interior perimeter of this tube, identified as 5.

FIG. 4 illustrates schematically two possible states of the sachet with a flat bottom, the front and rear faces of the sachet, after forming but before being subjected to the pressure of the piston 3 inside the tube 5, adopt the positions with the references 13 and 13′. Once the sachet with a flat bottom has been positioned inside its tube 5, the piston 3 places said sachet and its contents under pressure in the course of its displacement in the direction of the opposite end, that is to say the exchange surface 17. Once the sachet has been subjected to the pressure of the piston 3, the front and rear faces are deformed under the action of the piston 3 and perfectly match the interior perimeter of the tube identified as 5. This novel configuration is also identified in FIG. 4 under the positions with the references 12 and 12′, the arrows 38 symbolizing the displacement of these faces once they have been subjected to the action of the piston 3. These faces 12 and 12′ thus come into contact and match perfectly the internal surface 23 of the tube 5. The height of this sachet with a flat bottom 9 is adjusted according to the quantity of product 4 desired in this package and within the limit of the quantity which the tube 5 may contain.

The material constituting the sachet 9 must be sufficiently soft for it to be able to deform under the action of the piston 3, while being sufficiently tough for it not to rupture under the action of this same piston 3.

The enclosure is implemented by a tube identified as 5 in FIG. 3, and may be of a plastic nature, which is implemented in the form of a PEBD so as to fulfill the technical functions associated with its use, such as lightness, ease of cleaning, ease of assembly with the piston 3 and with the body of the dosing gun 1, but also with the constraints associated with the packaging costs. The principle of this tube 5 is to be reused or to be capable of being reused until it is no longer capable of assuring the functions for which it was developed, with the objective of reducing the consumption of packaging material used in the agro-food industry and in fast-food restaurants. The thickness of this tube 5 must be sufficient to withstand the pressure applied to the sachet with a flat bottom 9 and its contents 4 by the piston 3 in the course of its use. This tube 5 is provided with two perfectly symmetrical ends, one closed off by the piston 3 and the other by the sachet with a flat bottom 9, the dispensing surface 17 closing off the other end. It is also preferable for the cross section of this tube 5 to be of circular shape in order to have an equal distribution of the internal forces when the piston applies a pressure to the sachet with a flat bottom 9 and, by its nature, to its product 4.

The piston 3 has the same cross section as the tube 5. It may also be of a plastic nature, which is implemented in the form of a polypropylene so as to fulfill the technical functions associated with its loadings such as the resistance to friction between the internal surface of the tube, identified as 23, and the surface of the piston with the reference 24 in FIG. 3. In the course of the dosage operation, the piston 3 is in movement along the tube 5 in the direction of the exchange surface 17. During this same dosage operation, the folds of the sachet with a flat bottom around the zone 26 may make it necessary to cause any air that may be trapped inside the enclosure of the tube 5 to escape. As illustrated, openings implemented in the form of grooves 14 may be made on the piston 3 at four angles, although this function may also be effected by simple perforations opening onto this same face 3. The two opposing surfaces of this piston with the reference 3 are perfectly identical, which permits the use of both sides of this piston during dosage operations.

It is through the exchange surface 17 situated on the base 37 of the sachet with a flat bottom 9 that the product 4 is expelled. It is in this zone 17 that one or a plurality of openings 7 are present in order to perform the dosage of the product, and these are implemented in the form of cuts in the material, and they may adopt the form of a cross for each opening. When the sachet with a flat bottom 9 is placed under pressure inside its tube 5, the flaps 19 formed by the cross deform under the pressure thereby allowing the product 4 to escape via these openings 7. When the pressure is no longer being exerted on the sachet with a flat bottom 9, the flaps 19 return to their closed or partially closed position. Preferably, the surface 17 may adopt a circular form, as shown in FIG. 5, which, once the sachet 9 has been mounted in its enclosure 5, shares the same axis 36 with the tube 5, the piston 3 and a reinforcement 10, as depicted in FIG. 3, and thus permits optimal dispensing. In the course of its use in the dosing gun 1, the edge 22 comes into contact with the internal face 39 of the edge 8, as depicted in FIG. 2.

A pealable seal 11 is necessary in order to ensure the integrity of the product 4 from the time of its wrapping, during its storage and its transport and until it is in its final place of use. This seal covers the exchange surface 17 so as to render the package hermetic in relation to the openings 7 that have been made in the flexible film on the base 37 of the sachet with a flat bottom 9. This seal 11 may be implemented by a circular shape, as depicted in FIGS. 5 and 3, and may be assembled with the sachet by thermal welding—this welding is symbolized by the broken line 18, which likewise permits the limits of the exchange surface 17 to be defined. This welding must be sufficient to ensure the sealing, but it must also be sufficiently strong not to give way under the pressure of its contents in the course of storage and transport operations. This seal must be pealable, and it must be capable of being removed easily by the user at the final place without damaging the exchange surface 17. This welding serves as a tamper-proof seal and permits the integrity of its contents to be guaranteed.

In order to permit an easy grip on said seal 11, a tongue or easy-opener 25 may be used in order to make it possible to help the final user to remove the latter without the need to resort to a tool which may cause damage to the package. The material of the seal may be of a multi-layer nature in order to combine the necessary functions such as the peelability, in the form of a peelable PE, with a metalized PET for the permeability needs of the multi-layer complex.

In the course of the dosage operation of the product 4, it is possible for the exchange surface 17 to deform excessively under the action of the piston 3, which may cause the sachet with a flat bottom 9 to be expelled from the body of the dosing gun 1, in spite of the edges 8 of the dosing gun illustrated in FIG. 2 having the function of containing and/or retaining the package under the action of the shaft 2, and, by its nature, the piston 3, in the course of dispensing operations. In order to mitigate this undesired effect, a supplementary accessory may be added to this assembly; a reinforcement 10 may be installed on the dosing gun 1 so as to impart rigidity to the exchange surface 17 and to extend the function of the edges identified as 8 by increasing the contact surface between the surface 39 and the flat bottom of the sachet 37 with the aim of retaining the sachet with a flat bottom 9 in its optimal position of use. The reinforcement 10 permits rigidity to be imparted to the exchange surface 17 once the unit formed by the tube 5, the piston 3 and the sachet with a flat bottom 9 has been assembled inside the dosing gun 1. This reinforcement 10 may be of a plastic nature, of the polypropylene type, in a physical realization of the present invention. The shape of this reinforcement 10 is the same as the cross section of the tube 5, that is to say circular. In order to fulfill its primary function, this reinforcement 10 has an internal face 21, an external face 41 and a locking system 6. The interior surface 21 is in contact with the bottom of the flat sachet 37 sufficiently for it to retain the sachet with a flat bottom 9 during dispensing operations, as shown in FIG. 2, yet without impeding the dispensing of the product through its openings 7 and/or even closing off the dispensing surface 17.

As illustrated in FIG. 2, hooks identified as 6 permit this reinforcement 10 to be locked/secured to the frame of the dosing gun 1 at its edges 8. These hooks 6 are equipped with barbs 42 in contact with the external face 40 of the edges 8, making it possible to maintain the external surface 41 of the reinforcement 10 in contact with the interior face 39 of the edges 8 in the course of its multiple loadings, although likewise making it possible to separate and/or disassemble them, for example in the course of cleaning operations. The principle of this reinforcement 10 is to be reused or to be capable of being reused until it is no longer capable of assuring the functions for which it was developed, with the objective of reducing the consumption of packaging materials used in the agro-food industry and in fast-food restaurants. This option has been selected with an economic and ecological goal in mind. However, as illustrated in FIG. 7, it may be the case that this reinforcement 10 is welded, via its external face 41, to the sachet with a flat bottom at its base 37 or at its dispensing surface 17, the welding being the means of assembling and locking these two elements together. This solution requires each package to have its own reinforcement, and it cannot be disassociated from the latter.

In the course of its implementation and installation in the dosing gun, the unit adopts the shape according to FIG. 3, and it may adhere to the following manipulation and installation procedure: lock the reinforcement 10 on the edges 8 of the dosing gun 1 if the reinforcement is required, take the tube 5 and from one side insert the piston 3, from the other side introduce the sachet 9 with the dispensing face 17 closing off the other end, and then, once the piston 3, the tube 5 and the sachet 9 have been assembled, the dosing gun 1 having its shaft 2 retracted to its maximum extent so as to be able to insert the piston/tube/sachet assembly. Once the piston/tube/sachet assembly has been inserted, the shaft 2 is advanced until its tip 20 is in contact with the piston 3. The dosing gun is ready for use. Once the sachet has been emptied of its contents, the piston is in a position very close to the end opposite its original position, or very close to the edge 8, all that remains between these two elements being a sachet 9 that has been emptied and compressed between these two surfaces. In order to optimize the efficiency in the restaurant, the concept permits this tube 5 and its piston 3 to be used in both directions, that is to say it is not necessary to replace the piston in its original position, and it is sufficient simply to return the unit in order to utilize the other side by inserting a new sachet from the available side.

From an industrial point of view, and according to FIG. 6, the sachet with a flat bottom 9 may be formed, filled and welded on a semi-automated or automated wrapping line of the so-called FFS or “Form Fill Seal” type, starting from a reel of flexible film. In this same figure, the element 28 represents the tool permitting the cutting of these openings 7 in the surface 17, and the element 29 represents the tool permitting the sealing of the element 11. As illustrated, the one or more cuts intended to produce the one or more openings 7 on the exchange surface 17, as well as the sealing operation of these same surfaces, must be carried out before the operations for the forming, filling and welding of the sachet 9.

These operations are implemented by the element 30, symbolizing the creation and the forming of the flat bottom in the so-called “W” shape, the element 31 symbolizing the so-called “flat” configuration of the sachet 9, the element 33 representing the sachet with a flat bottom that is cut and welded on its lateral sides 15, capable of bringing about ejections 32 depending on the selected welding profile, the element 34 symbolizing the filling operation, and the element 35 symbolizing the sachet welded to the upper part and ready to be dispatched to the final place of use. This type of package may also be performed, that is to say it may be sold or dispatched in an empty and flat state, symbolized by the element (33) in FIG. 6; already being provided with these cuts 7, with the seal 11 as well as with the two lateral welds 15, these empty packages are then dispatched or sold to another company using equipment of the so-called FS or “Fill Seal” type, the latter company only being required to undertake the operation of filling and top welding 26 in order to obtain the finished and ready-for-use sachet. This solution is often adopted so as to meet any needs in terms of costs, flexibility and industrial constraints, such as the available space, or commercial constraints such as low annual quantities or so-called small-volume production runs.

1. A device for packaging and dispensing any type of viscous and/or pasty sauce and condiment, characterized in that it includes:
a reusable tube (5), generally of cylindrical shape, having two perfectly similar ends,
a reusable piston (3) exhibiting the same profile as said tube (5), having its two perfectly similar faces and being positioned inside said tube (5) via one of its ends,
a sachet with a flat bottom (9) positioned inside said tube (5) via the other end, having two lateral welds (15) and having a partially or totally plane surface (37) and an exchange surface (17) having at least one opening (7) for dispensing the product (4), and
a seal (11) connected to the sachet (9) covering said surface (17) and providing easy opening (25).

2. The device as claimed in claim 1, characterized in that the two lateral welds (15) of the sachet with a flat bottom (9) are shaped in the form of a “W”, making it possible to obtain a partially or totally flat bottom (37).

3. The device as claimed in claim 1, characterized in that the sachet with a flat bottom (9) is constructed from a flexible film.

4. The device as claimed in claim 3, in which the flexible film comes from a reel (27).

5. The device as claimed in claim 1, characterized in that the exchange surface (17) is an integral part of the sachet (9) and is situated on the partially or totally flat bottom (37).

6. The device as claimed in claim 5, characterized in that said exchange surface (17) has a plurality of flaps (19) forming a minimum of one opening (7) allowing the product (4) to be dispensed.

7. The device as claimed in claim 1, characterized in that it comprises a reinforcement (10) capable of adding rigidity to the exchange surface (17) once the unit formed by the tube (5), the piston (3) and the sachet with a flat bottom (9) has been assembled in the dosing gun (1).

8. The device as claimed in claim 1, characterized in that the sachet with a flat bottom (9) exhibits two lateral surfaces (12, 12′) perfectly matching the interior surface (23) of the tube (5), when the sachet with a flat bottom (9) is subjected to pressure by the piston (3).

9. The device as claimed in claim 1, characterized in that the surface (37) has a hot melt coating allowing the seal (11) to be assembled and welded along a welding line (18).

10. The device as claimed in claim 1, characterized in that the piston (3) has openings (14).

11. The device as claimed in claim 7, characterized in that the reinforcement (10) is assembled onto the body of the dosing gun (1) or onto the bottom of the flat sachet (9) at its base (37).

12. A method of manufacturing the device for packaging and dispensing any type of viscous and/or pasty sauce and condiment according to any one of claims 1 to 11, characterized in that it comprises:
a stage of cutting said openings (7),
a stage of closing off the exchange surface (17) by its seal (11),
a stage of forming (30) the sachet in the shape of a “W”,
a stage of flattening (31) the sachet (9),
a stage of welding (33) the lateral sides of the sachet,
a stage of filling (34), and
a stage of welding (35) the upper part of the sachet with a flat bottom (9).
